(19) United States
(12) Patent Application Publication
(10) Pub. No.: US 2019/0369760 A1
(43) Pub. Date: Dec. 5, 2019

(54) TOUCH SENSOR AND TOUCH PANEL HAVING THE SAME

(71) Applicants: Interface Technology (ChengDu) Co., Ltd., Sichuan (CN); Interface Optoelectronics (ShenZhen) Co., Ltd., Guangdong (CN); General Interface Solution Limited, Miaoli County (TW)

(72) Inventors: Yue-Feng YANG, Guangdong (CN); Po-Lin CHEN, Guangdong (CN); Yen-Heng HUANG, Guangdong (CN)

(21) Appl. No.: 16/004,422

(22) Filed: Jun. 10, 2018

(30) Foreign Application Priority Data
Jun. 4, 2018 (CN) 201810563925.5

(51) Int. Cl. G06F 3/041

(52) U.S. Cl. CPC G06F 3/041; G06F 2203/04102; G06F 2203/04103

(57) ABSTRACT

A touch sensor includes a touch sensing layer, a bonding pad and at least one conductive trace. The touch sensing layer has an active region and a periphery region surrounding the active region. The periphery region includes a first folding region at a first side of the periphery region. When the first folding region is folded, the first folding region is overlapped with a first portion of the active region. The bonding pad is disposed at the first folding region of the periphery region of the touch sensing layer. Two ends of the conductive trace are respectively connected to the touch sensing layer and the bonding pad. The conductive trace is sequentially disposed along the first side, a second side, and a third side of the periphery region, and the second side is adjacent to the first side and the third side.

### CROSS-REFERENCE TO RELATED APPLICATION

This application claims priority to Chinese Application Serial Number 201810563925.5 filed Jun. 4, 2018, the disclosure of which is incorporated herein by reference in its entirety.

### BACKGROUND

In a conventional touch panel having a touch sensing layer, portions of the touch sensing layer at the two sides of the touch panel are folded to enable two sides and top side of the touch panel to have a narrow border design. However, because a bonding pad is required to be disposed at a bottom side of the touch sensing layer, the bottom side of the touching sensing layer needs more space, and thus the degree of width shrinkage of the bottom side border width is limited, and only three sides of the conventional touch panel may have the narrow border design.

### SUMMARY

One embodiment of the present disclosure is to provide a touch sensor. The touch sensor includes a touch sensing layer, a bonding pad and at least one conductive trace. The touch sensing layer has an active region and a periphery region surrounding the active region. The periphery region includes a first folding region at a first side of the periphery region. When the first folding region is folded, the first folding region is overlapped with a first portion of the active region. The bonding pad is disposed at the first folding region of the periphery region of the touch sensing layer. Two ends of the conductive trace are respectively connected to the touch sensing layer and the bonding pad. The conductive trace is sequentially disposed along the first side, a second side, and a third side of the periphery region, and the second side is adjacent to the first side and the third side.

In some embodiments of the present disclosure, the periphery region further includes a second folding region disposed at the third side of the periphery region, and when the second folding region is folded, the second folding region is overlapped with a second portion of the active region.

In some embodiments of the present disclosure, when the first folding region and the second folding region are folded, the touch sensing layer has two folding lines that are substantially in parallel with each other.

In some embodiments of the present disclosure, the conductive trace has two portions respectively disposed on the first folding region and the second folding region.

In some embodiments of the present disclosure, the periphery region has a fourth side opposite to the second side, and the fourth side of the periphery region is free of conductive trace.

In the foregoing embodiments of the present disclosure, since the bonding pad is disposed at the first folding region of the touch sensor, the overall area of the touch sensor would not be affected by the area required for disposing the bonding pad after the first folding region is folded, and the width of the unfolded sides of the periphery region can be reduced.

Another embodiment of the present disclosure is to provide a touch panel. The touch panel includes a light-transmissive cover and a touch sensor. The touch sensor is disposed on the light-transmissive cover, and includes a touch sensing layer, a bonding pad and at least one conductive trace. The touch sensing layer has an active region and a periphery region surrounding the active region. The periphery region includes a first folding region at a first side of the periphery region. When the first folding region is folded, the first folding region is overlapped with a first portion of the active region, and the first portion of the active region is located between the first folding region and the light-transmissive cover. The bonding pad is disposed at the first folding region of the periphery region of the touch sensing layer. Two ends of the conductive trace are respectively connected to the touch sensing layer and the bonding pad. The conductive trace is sequentially disposed along the first side, a second side, and a third side of the periphery region, and the second side is adjacent to the first side and the third side.

In some embodiments of the present disclosure, the periphery region further includes a second folding region disposed at the third side of the periphery region. When the second folding region is folded, the second folding region is overlapped with a second portion of the active region, and the second portion of the active region is located between the second folding region and the light-transmissive cover.

In some embodiments of the present disclosure, when the first folding region and the second folding region are folded, the touch sensing layer has two folding lines that are substantially in parallel with each other. A distance between one of the two folding lines and a first edge of the light-transmissive cover is substantially the same as a distance between the other folding line and a second edge of the light-transmissive cover that is opposite to the first edge.

In some embodiments of the present disclosure, the periphery region of the touch sensing layer has a fourth side opposite to the second side. A distance between the second side and an edge of the light-transmissive cover is greater than or equal to a distance between the fourth side and another edge of the light-transmissive cover.

In some embodiments of the present disclosure, the touch panel further includes a display module disposed on the active region of the touch sensing layer. When the first folding region and the second folding region are folded, the first folding region and the second folding region are on the display module.

In the foregoing embodiments of the present disclosure, since the bonding pad is disposed on the first folding region of the touch sensor, the first folding region can be overlapped with the first portion of the active region when the first folding region is folded, thus achieving a narrow border design at folded sides of the touch panel. Furthermore, since the side of the periphery region of the touch sensing layer that is not configured for disposing the bonding pad merely has the conductive traces or is free of conductive traces, the narrow border design at unfolded sides of the touch panel can also be achieved. Therefore, the narrow border design can be achieved at four sides of the touch panel in the present disclosure.

### BRIEF DESCRIPTION OF THE DRAWINGS

FIG. 1 is a top view of a touch sensor according to one embodiment of the present disclosure.

FIG. 2 is a perspective view of the touch sensor of FIG. 1 mounted on a touch panel.

FIG. 3 is a top view of the touch panel shown in FIG. 2.

### DETAILED DESCRIPTION

The following disclosure provides different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed that are between the first and second features, such that the first and second features are not in direct contact. In addition, the present disclosure may repeat reference numerals and/or letters in the various examples. This repetition does not in itself dictate a relationship between the various embodiments and/or configurations discussed.

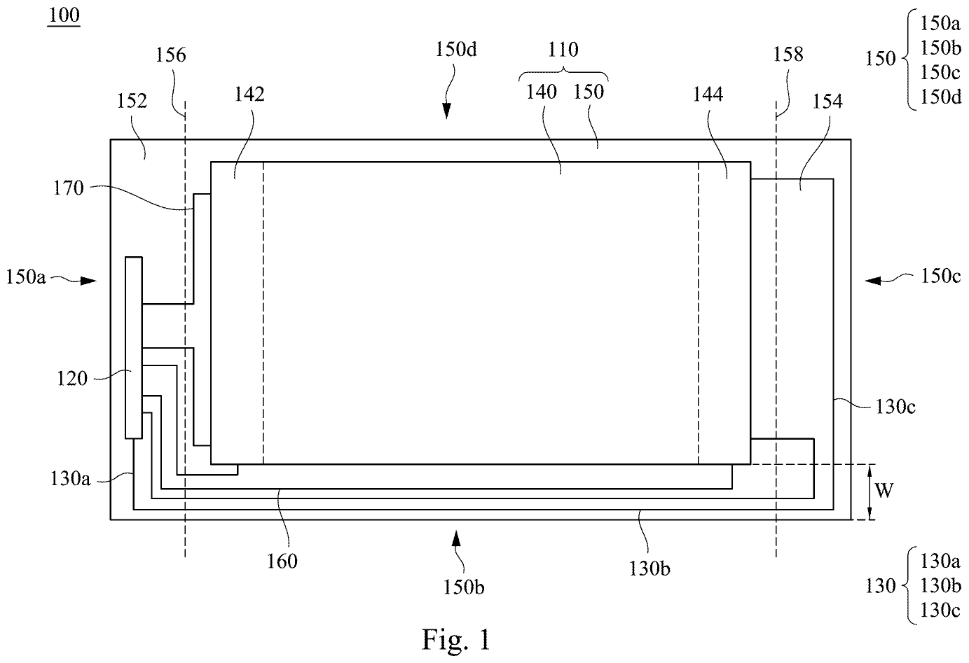

FIG. 1 is a top view of a touch sensor 100 according to one embodiment of the present disclosure. The touch sensor 100 includes a touch sensing layer 110, a bonding pad 120, and conductive traces 130.

The touch sensing layer 110 includes an active region 140 and a periphery region 150. The periphery region 150 can be divided into a first side 150a, a second side 150b, a third side 150c, and a fourth side 150d. The second side 150b is adjacent to the first side 150a and the third side 150c, and the fourth side 150d is adjacent to the first side 150a and the third side 150c. The first side 150a is opposite to the third side 150c, and the second side 150b is opposite to the fourth side 150d. The periphery region 150 includes a first folding region 152 and a second folding region 154. The first folding region 152 is located at the first side 150a of the periphery region 150, and the second folding region 154 is located at the third side 150c of the periphery region 150. The bonding pad 120 is disposed at the first folding region 152 of the periphery region 150 of the touch sensing layer 110. Two ends of the conductive traces 130 are electrically connected to the touch sensing layer 110 and the bonding pad 120 respectively. The conductive traces 130 are sequentially disposed along the first side 150a, the second side 150b, and the third side 150c of the periphery region 150.

In the present embodiment, when the first folding region 152 is folded, a portion of the first folding region 152 is overlapped with a first portion 142 of the active region 140. The first side 150a of the periphery region 150 has a first folding line 156. The first folding line 156 is at the first side 150a of the periphery region 150, and first folding line 156 is located close but not connected to the active region 140. When the second folding region 154 is folded, a portion of the second folding region 154 is overlapped with a second portion 144 of the active region 140. The third side 150c of the periphery region 150 has a second folding line 158. The second folding line 158 is at the third side 150c of the periphery region 150, and second folding line 158 is located close but not connected to the active region 140. Furthermore, the first folding line 156 and the second folding line 158 are substantially in parallel with each other. In the present embodiment, the second side 150b and the fourth side 150d of the periphery 150 are not folded.

In the present embodiment, the conductive traces 130 have line segments 130a and line segments 130b respectively disposed at the first folding region 152 and the second folding region 154, and line segments 130c disposed at the second side 150b. Furthermore, in the present embodiment, the touch sensor 100 further includes conductive traces 160 and conductive traces 170. Two ends of each of the conductive traces 160 and 170 are electrically connected to the touch sensing layer 110 and the bonding pad 120 respectively. The conductive traces 160 are sequentially disposed along the first side 150a and the second side 150b of the periphery region 150, and the conductive traces 170 are disposed along the first side 150a of the periphery region 150. In other words, in the present embodiment, when the first folding region 152 is folded, the bonding pad 120 is overlapped with the first portion 142 of the active region 140, and the line segments 130a of the conductive traces 130, the line segments of the conductive traces 160 at the first side 150a, and the conductive traces 170 are folded. When the second folding region 154 is folded, the line segments 130c of the conductive traces 130 are folded. Furthermore, in the present embodiment, the fourth side 150d of the periphery region 150 is free of conductive traces. The conductive traces 130, 160 and 170 can be fan-out traces, and the conductive traces 130, 160 and 170 are made of conductive material.

In the present embodiment, since the bonding pad 120 is disposed at the first folding region 152, when the first folding region 152 and the second folding region 154 are folded, a portion of the first folding region 152 is overlapped with a first portion 142 of the active region 140, and a portion of the second folding region 154 is overlapped with a second portion 144 of the active region 140. Therefore, the overall area of the touch sensor 100 would not be affected by the area required for disposing the bonding pad 120. Furthermore, the second side 150b of the periphery 150 has a width W, and the width W is the distance between the edge of the active region 140 close to the second side 150b and the edge of the periphery region 150. Compared with the conventional touch sensor in which the bonding pad is disposed at the bottom side of the periphery region, the width W of the second side 150b of the touch sensor 100 in the present disclosure can be further reduced.

In an embodiment, the bonding pad 120 can be disposed at the first side 150a or the third side 150c of the periphery region 150. The widths of the first folding region 152 and the second folding region 154 can be the same or different. Furthermore, the number of the conductive traces in FIG. 1 is merely shown as an example, and does not intend to limit the present disclosure.

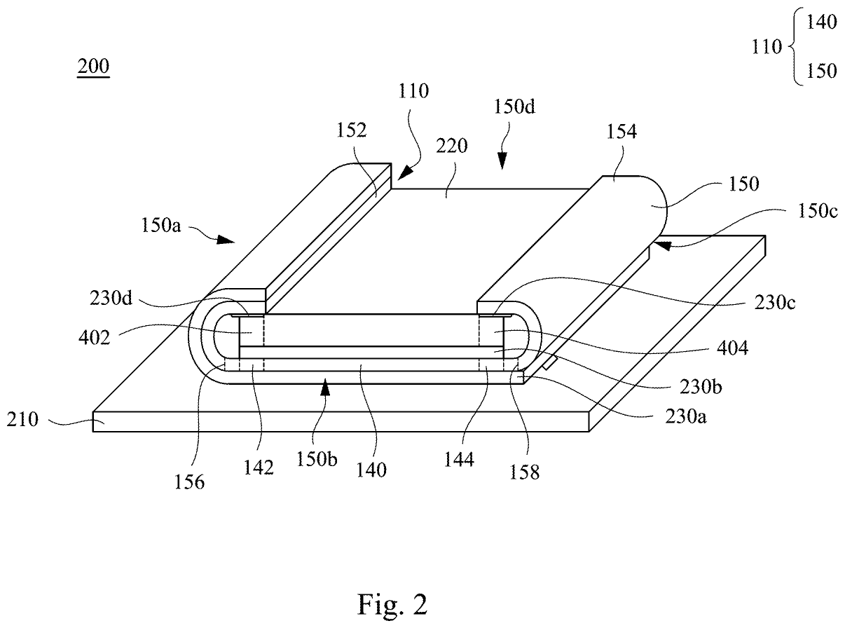

FIG. 2 is a perspective view of the touch sensor 100 of FIG. 1 mounted on a touch panel 200. The touch panel 200 includes the touch sensor 100, a light-transmissive cover 210 and a display module 220. The touch sensing layer 110, the bonding pad 120, and the conductive traces 130, 160 and 170 of the touch sensor 100 are disposed in the same way as described above. However, to simplify the figure, the bonding pad 120 and the conductive traces 130, 160 and 170 of the touch sensor 100 are not shown in FIG. 2. The touch sensor 100 is disposed on the light-transmissive cover 210. The display module 220 is disposed at the active region 140 of the touch sensing layer 110.

In the present embodiment, a first portion 402 of the display module 220 is overlapped with the first portion 142 of the active region 140, and a second portion 404 of the display module 220 is overlapped with the second portion 144 of the active region 140. When the first folding region 152 is folded, the first portion 402 of the display module 220 is located between the first folding region 152 and the first portion 142 of the active region 140. When the second folding region 154 is folded, the second portion 404 of the display module 220 is located between the second folding region 154 and the second portion 144 of the active region 140.

In the present embodiment, the touch panel 200 further includes optically clear adhesive layers 230a, 230b, 230c and 230d. The foregoing laminated structure of the touch panel 200 is merely shown as an example. Users may add more layers of materials and structures in accordance with the design requirements without affecting the functions and the relative positions among the light-transmissive cover 210, the touch sensor 110, and the display module 220.

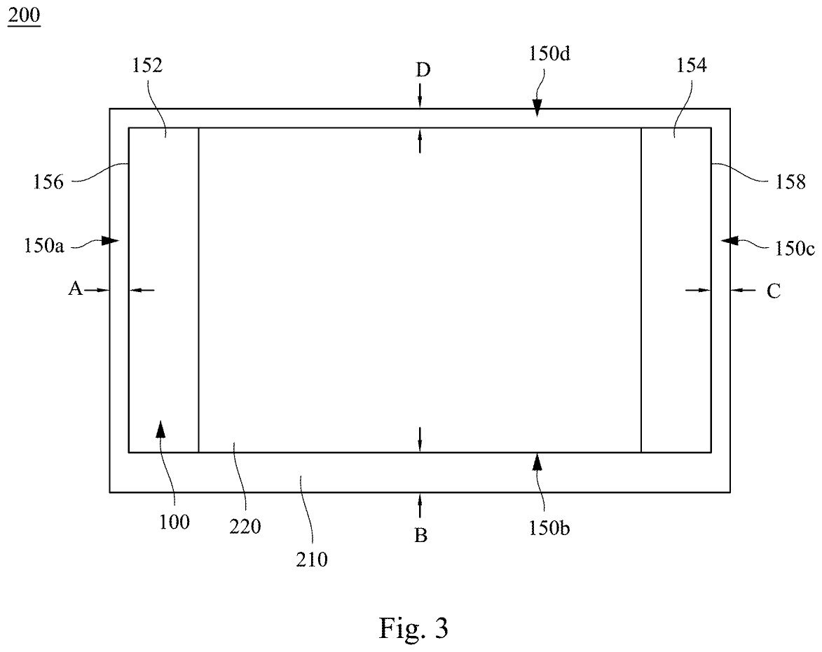

FIG. 3 is a top view of the touch panel shown in FIG. 2. Reference is made to FIG. 2 and FIG. 3 simultaneously. In order to describe conveniently, the optically clear adhesive layer 230a is omitted in FIG. 3. The touch sensor 100 includes the first folding line 156 and the second folding line 158. In the present embodiment, there is a distance A between the first folding line 156 and an edge of the light-transmissive cover 210 close to the first side 150a, a distance B between the second side 150b of the touch sensor 100 and an edge of the light-transmissive cover 210 close to the second side 150b, a distance C between the second folding line 158 and an edge of the light-transmissive cover 210 close to the third side 150c, and a distance D between the fourth side 150d of the touch sensor 100 and an edge of the light-transmissive cover 210 close to the fourth side 150d. In the present embodiment, the distance A, the distance C, and the distance D can be in the range between 0 to 3 mm, and the distance B can be in the range between 0 to 6 mm.

In the present embodiment, the bonding pad 120 (refer to FIG. 1) can be disposed on the first folding region 152 in FIG. 3. When the first folding region 152 and the second folding region 154 are folded, the first folding region 152 can be overlapped with the first portion 142 of the active region 140 and the first portion 402 of the display module 220, and the second folding region 154 can be overlapped with the second portion 144 of the active region 140 and the second portion 404 of the display module 220. Therefore, the narrow border design at the first side 150a and the third side 150c of the touch panel 200 can be achieved. Furthermore, since the second side 150b of the periphery region 150 merely has the conductive traces, and the fourth side 150d of the periphery region 150 is free of conductive traces, the second side 150b and the fourth side 150d of the touch panel 200 which are unfolded can also have narrower borders. Therefore, the narrow border design can be achieved at fourth sides of the touch panel 200 in the present disclosure, and is not limited by the bonding pad 120 disposed on the first folding region 152.

The foregoing has outlined features of several embodiments. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A touch sensor, comprising:
a touch sensing layer having an active region and a periphery region surrounding the active region, wherein the periphery region comprises a first folding region at a first side of the periphery region, and when the first folding region is folded, the first folding region is overlapped with a first portion of the active region;
a bonding pad disposed at the first folding region of the periphery region of the touch sensing layer; and
at least one conductive trace, wherein two ends of the conductive trace are respectively electrically connected to the touch sensing layer and the bonding pad, the conductive trace is sequentially disposed along the first side, a second side, and a third side of the periphery region, and the second side is adjacent to the first side and the third side.

2. The touch sensor of claim 1, wherein the periphery region further comprises:
a second folding region disposed at the third side of the periphery region, wherein when the second folding region is folded, the second folding region is overlapped with a second portion of the active region.

3. The touch sensor of claim 2, wherein when the first folding region and the second folding region are folded, the touch sensing layer has two folding lines that are substantially in parallel with each other.

4. The touch sensor of claim 2, wherein the conductive trace has two portions respectively disposed on the first folding region and the second folding region.

5. The touch sensor of claim 1, wherein the periphery region has a fourth side opposite to the second side, and the fourth side of the periphery region is free of conductive traces.

6. A touch panel, comprising:
a light-transmissive cover; and
a touch sensor disposed on the light-transmissive cover, the touch sensor comprising:
a touch sensing layer having an active region and a periphery region surrounding the active region, wherein the periphery region has a first folding region at a first side of the periphery region, and when the first folding region is folded, the first folding region is overlapped with a first portion of the active region, and the first portion of the active region is located between the first folding region and the light-transmissive cover;
a bonding pad disposed at the first folding region of the periphery region of the touch sensing layer; and
at least one conductive trace, wherein two ends of the conductive trace are respectively electrically connected to the touch sensing layer and the bonding pad, the conductive trace is sequentially disposed along the first side, a second side, and a third side of the periphery region, and the second side is adjacent to the first side and the third side.

7. The touch panel of claim 6, wherein the periphery region further comprises:
a second folding region disposed at the third side of the periphery region, wherein when the second folding region is folded, the second folding region is overlapped with a second portion of the active region, and the second portion of the active region is located between the second folding region and the light-transmissive cover.

8. The touch panel of claim 7, wherein when the first folding region and the second folding region are folded, the touch sensing layer has two folding lines that are substantially in parallel with each other, and a distance between one of the two folding lines and a first edge of the light-transmissive cover is substantially the same as a distance between the other folding line and a second edge of the light-transmissive cover opposite to the first edge.

9. The touch panel of claim 7, wherein the periphery region of the touch sensing layer has a fourth side opposite to the second side, a distance between the second side and an edge of the light-transmissive cover is greater than or equal to a distance between the fourth side and another edge of the light-transmissive cover.

10. The touch panel of claim 7, further comprising:
a display module disposed at the active region of the touch sensing layer, wherein when the first folding region and the second folding region are folded, the first folding region and the second folding region are on the display module.
